(19) United States
(12) Patent Application Publication
(10) Pub. No.: US 2009/0228922 A1
(43) Pub. Date: Sep. 10, 2009

(54) METHODS AND DEVICES FOR PRESENTING AN INTERACTIVE MEDIA GUIDANCE APPLICATION

(75) Inventors: Khalil Haj-khalil, Tarzana, CA (US); Marvin Charles Carlberg, Los Angeles, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: United Video Properties, Inc., Los Angeles, CA (US)

(21) Appl. No.: 12/051,808

(22) Filed: Mar. 19, 2008

Related U.S. Application Data
(60) Provisional application No. 61/035,275, filed on Mar. 10, 2008.

(51) Int. Cl. G06F 3/00

(52) U.S. Cl. 725/38

(57) ABSTRACT

Methods and devices for presenting an interactive media guidance application are provided in accordance with various embodiments. In some embodiments, methods for presenting an interactive media guidance application in a user equipment device are provided, the methods comprising: receiving a video signal; presenting the video signal on a display in a first area and in a first configuration; receiving one or more commands from a user; and, in response to receiving the one or more commands: selecting a second area of the video signal that is less than the first area of the video signal and causing the second area of the video signal to be presented on the display in a larger size than the second area of the video signal when displayed in the first configuration.

This application claims the benefit of U.S. Provisional Application No. 61/035,275, filed Mar. 10, 2008, the disclosure of which is hereby incorporated by reference herein in its entirety.

### BACKGROUND OF THE INVENTION

In recent years, digital video recorders (DVRs), such as those manufactured by TiVo, Inc. and those built into set-top boxes provided by local cable companies, have become readily available to consumers. A DVR allows a television viewer to pause, rewind, or playback live content that has been stored or cached on the DVR. The DVR also allows the television viewer to record content, where the recorded content is stored on the DVR for future playback.

When a television viewer is watching live content and a particular event occurs (e.g., a questionable or close call in a sporting event), the viewer typically navigates through the stored or cached content to review the particular event. For example, the viewer may rewind and replay a sequence of frames that includes the particular event. In another example, the viewer may rewind and pause on a single frame of the content. However, the task of reviewing the particular event with sufficient detail is often difficult.

Accordingly, there exists a need for mechanisms that overcome these and other deficiencies in prior art systems.

### SUMMARY OF THE INVENTION

Methods and devices for presenting an interactive media guidance application are provided in accordance with various embodiments of the present invention. In some embodiments, methods for presenting an interactive media guidance application in a user equipment device are provided, the methods comprising: receiving a video signal; presenting the video signal on a display in a first area and in a first configuration; receiving one or more commands from a user; and, in response to receiving the one or more commands: selecting a second area of the video signal that is less than the first area of the video signal and causing the second area of the video signal to be presented on the display in a larger size than the second area of the video signal when displayed in the first configuration.

In some embodiments, devices for presenting an interactive media guidance application are provided, the devices comprising: processing circuitry that: receives a video signal; causes the video signal to be presented in a first area and in a first configuration; receives one or more commands from a user; and, in response to receiving the one or more commands: selects a second area of the video signal that is less than the first area of the video signal and causes the second area of the video signal to be presented in a larger size than the second area of the video signal when displayed in the first configuration.

In some embodiments, devices for presenting an interactive media guidance application are provided, the devices comprising: means for receiving a video signal; means for presenting the video signal on a display in a first area and in a first configuration; means for receiving one or more commands from a user; and, in response to receiving the one or more commands: means for selecting a second area of the video signal that is less than the first area of the video signal and means for presenting the second area of the video signal on the display in a larger size than the second area of the video signal when displayed in the first configuration.

### BRIEF DESCRIPTION OF THE DRAWINGS

FIG. 1 illustrates an example of a grid display in an interactive media guidance application in accordance with some embodiments of the present invention.

FIG. 2 illustrates an example of a mosaic display in an interactive media guidance application in accordance with some embodiments of the present invention.

FIG. 3 illustrates an example of user equipment devices that may be used to implement an interactive media guidance application in accordance with some embodiments of the present invention.

FIG. 4 illustrates an example of a system for implementing an interactive media guidance application in accordance with some embodiments of the present invention.

FIG. 5 illustrates an example of a process for presenting an interactive media guidance application that displays zoom windows in accordance with some embodiments of the present invention.

FIG. 6 illustrates an example of a video content display in an interactive media guidance application in accordance with some embodiments of the present invention.

FIGS. 7A and 7B illustrates an example of zooming into a video content display using a highlighted window in an interactive media guidance application in accordance with some embodiments of the present invention.

FIG. 7C illustrates an example of a video content display with a zoom window in an interactive media guidance application in accordance with some embodiments of the present invention.

FIG. 8A illustrates an example of re-sizing zoomed video content in an interactive media guidance application in accordance with some embodiments of the present invention.

FIG. 8B illustrates an example of a video content display with a re-sized zoom window in an interactive media guidance application in accordance with some embodiments of the present invention.

FIG. 9 illustrates an example of a video content display with a zoom window and replay options in an interactive media guidance application in accordance with some embodiments of the present invention.

FIGS. 10 and 11 illustrate alternate examples of a video content display with a zoom window in an interactive media guidance application in accordance with some embodiments of the present invention.

FIG. 12 illustrates an example of a process for presenting indicators that indicate what zoom windows are available for viewing in accordance with some embodiments of the present invention.

FIGS. 13 and 14 illustrate an example of using indicators for selecting available zoom windows in accordance with some embodiments of the present invention of the present invention.

### DETAILED DESCRIPTION OF VARIOUS EMBODIMENTS

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content (which may be referred to herein as “programs” or “programming”) including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications may also allow users to navigate among and locate content related to the video content including, for example, video clips, articles, advertisements, chat sessions, games, etc.

With the advent of the Internet, mobile computing, and high-speed wireless networks, users are accessing media on personal computers (PCs) and other devices on which they traditionally did not, such as hand-held computers, personal digital assistants (PDAs), mobile telephones, vehicle entertainment systems, or other mobile devices. On these devices, users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

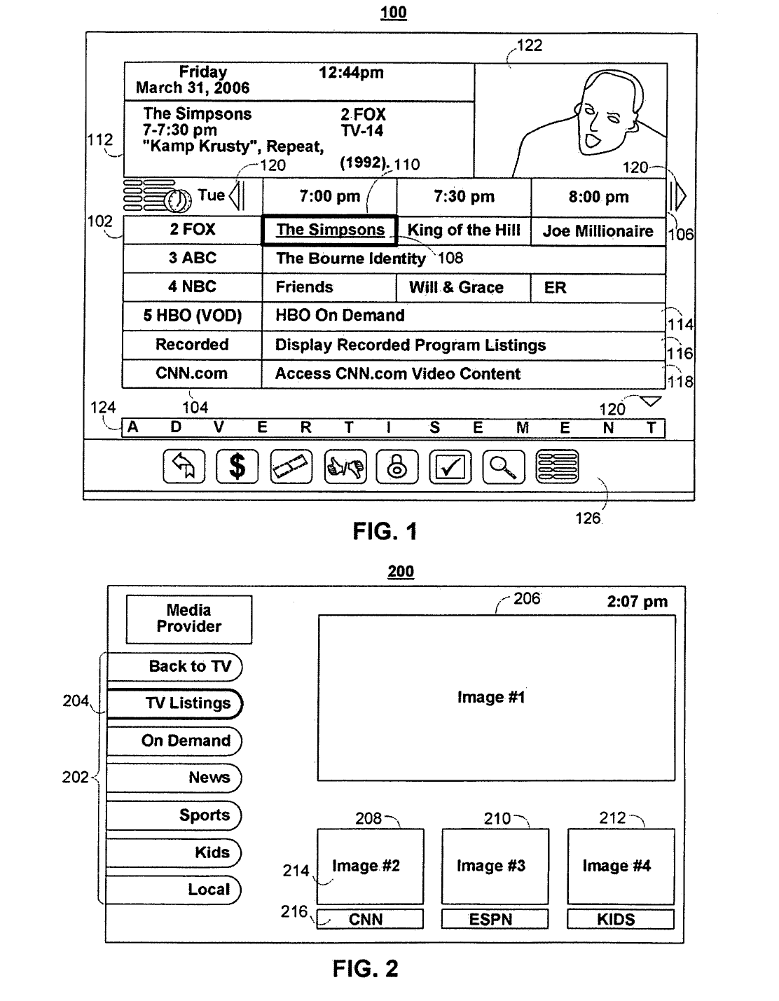

One of the functions of the media guidance application is to provide media listings and media information to users. FIGS. 1-2 show illustrative display screens that may be used to provide media guidance, and in particular media listings. The display screens shown in FIGS. 1-2, 6-11, 13 and 14 may be implemented on any suitable device or platform. While the displays of FIGS. 1-2, 6-11, 13, and 14 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, a media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, a media guidance application may also provide access to non-linear programming which is not provided according to a schedule. Non-linear programming may include content from different media sources including on-demand media content (e.g., video-on-demand (VOD)), Internet content (e.g., streaming media, downloadable media, etc.), locally stored media content (e.g., video content stored on a digital video recorder (DVR), digital video/versatile disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND, THE SOPRANOS, and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed may be based on user selection or guidance application definition (e.g., a display of only recorded and broadcast listings, only on-demand and broadcast listings, etc.), and any suitable permutation may be used. As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. Patent Application Publication No. 2003/0110499 A1, published Jun. 12, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting a program and/or channel as a favorite, purchasing a program, or other features. Options available from a main menu display may include search options, VOD options, parental control options, options to access various types of listing displays, options to subscribe to a premium service, options to edit a user's profile, options to access a browse overlay, or other options.

The media guidance application may be personalized based on a user's preferences. A personalized media guidance application may allow a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. Patent Application Publication No. 2005/0251827 A1, published Nov. 10, 2005, Boyer et al., U.S. Pat. No. 7,165,098, issued Jan. 16, 2007, and Ellis et al., U.S. Patent Application Publication No. 2002/0174430 A1, published Nov. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. The listings in display 200 are not limited to simple text (e.g., the program title) and icons to describe media. Rather, in display 200 the listings may provide graphical images including cover art, still images from the media content, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are illustrated as being of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

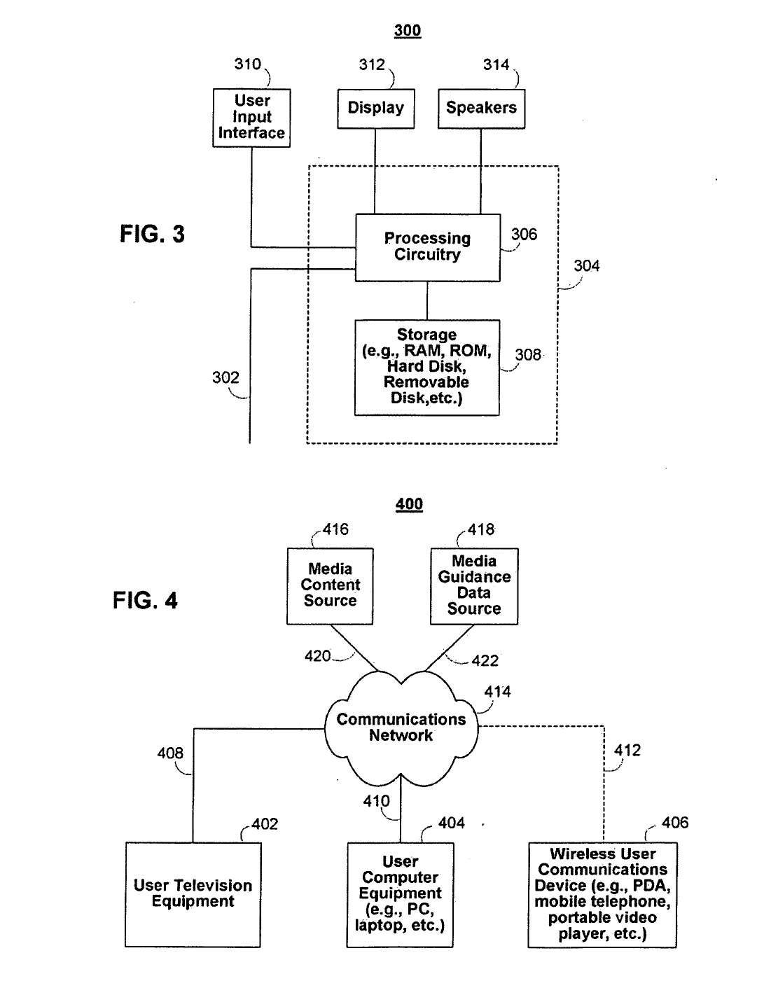

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, a wireless modem for communications with other equipment, a fiber-optic communications interface, a network interface (e.g., for an Ethernet network), and/or any other suitable interface. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Non-volatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV (now known as MSN TV) is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIGS. 3A and 3B and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to control, and/or maintain consistent media guidance application settings across, in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel may appear as a favorite on the user's in-home devices (e.g., user television equipment and user computer equipment) as well as the user's mobile devices, if desired. As another example, a user may specify using one device (e.g., a portable device or one mounted in the user's automobile) that a program is to be recorded on another of the user's devices (e.g., the user's home device). Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 may be coupled to communications network 414 via communications paths 408, 410, and 412, respectively. Communications network 414 may be one or more networks including the Internet, a mobile phone network, mobile device (e.g., Blackberry) network, cable network, public switched telephone network, a satellite network (e.g., a satellite television network or other satellite communications network), or other types of communications network or combinations of communications networks. BLACKBERRY is a trademark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a trademark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. Patent Application Publication No. 2003/0149988 A1, published Aug. 7, 2003, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Application Publication No. 2005/0251827 A1, published Nov. 10, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access a media guidance application on a website via a personal computer at their office, on a mobile device such as a PDA or web-enabled mobile telephone, on a vehicle-based system that is part of or coupled to a navigation system, etc. The user may set various settings (e.g., recordings, reminders, or other settings) on the guidance application to control the user's in-home equipment. The guide may control the user's equipment directly, or by communicating with a media guidance application on the user's in-home equipment. Various systems and methods for user equipment devices communicating, where the user equipment devices are in locations remote from each other, are discussed in, for example, Ellis et al., U.S. Patent Application Publication No. 2005/0028208 A1, published Feb. 3, 2005, which is hereby incorporated by reference herein in its entirety.

In a third approach, users of user equipment devices inside and outside a home can use their media guidance application to communicate directly with media content source 416 to access media content. Specifically, within a home, users of user television equipment 402 and user computer equipment 404 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

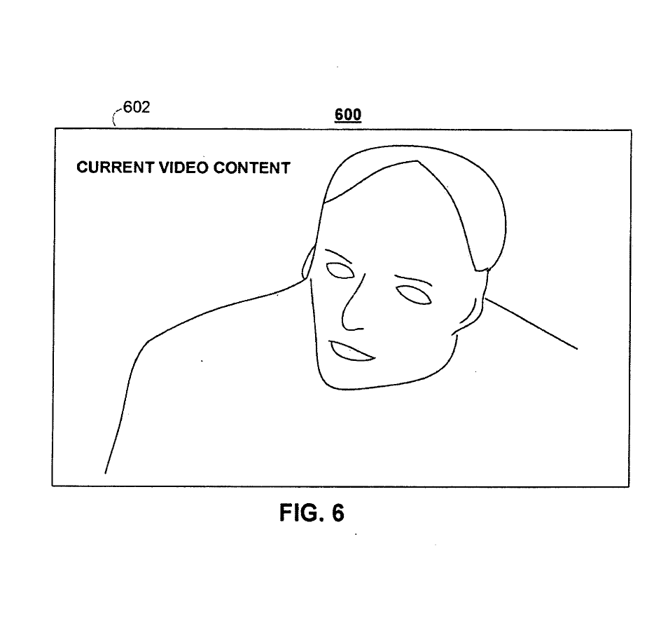

In some embodiments, the interactive media guidance application allow users to re-present or replay video content in a window (sometimes referred to herein as “zoomed regions” or “zoom windows”). The zoomed or enlarged content displayed in the display screen, video region, or any other suitable area may be provided from any suitable source. For example, the zoomed content may be an enlarged version of the video content currently received from the media content source. In another example, enhanced content (e.g., upconverted content) may be provided by media content sources, cameras controlled by a truck located outside of a sporting event, and/or any other suitable source. Illustrative examples of the interactive media guidance application with zoom windows or zoomed displays are shown in FIGS. 6-11.

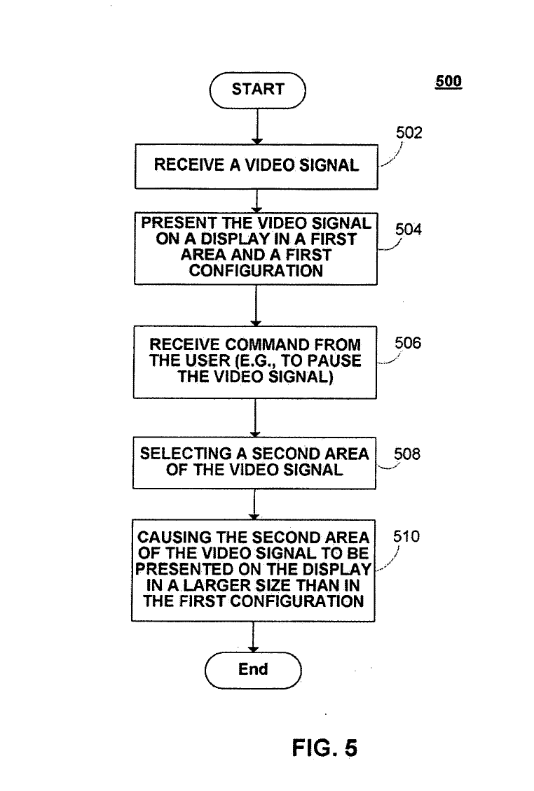

Turning to FIG. 5, a process 500 that may be used to implement an interactive media guidance application for enlarging the presentation of content is illustrated. As shown, beginning at step 502, process 500 may first receive a video signal. The video signal may include, for example, a sporting event, a live television program, recorded content, a program stored in a cache or buffer of a DVR, or any other suitable video content. Next, at step 504, the interactive media guidance application presents the received video signal on a display in a first area and a first configuration. For example, the received video signal may be displayed in an area that occupies the entire area of the display. However, it should be noted that while the displays, such as display 600 of FIG. 6, are illustrated as full screen displays, this is only illustrative.

At step 506, the interactive media guidance application may receive one or more commands from the user to re-present or replay video content. For example, the interactive media guidance application may receive a command from the user to pause the video signal (e.g., by selecting a pause button on the remote control). As another example, the interactive media guidance application may receive a command from the user to replay the previous ten seconds of a video signal (e.g., by selecting a replay button on the remote control).

In some embodiments, the interactive media guidance application may receive multiple commands from the user to re-present or replay video content. For example, the interactive media guidance application may receive a first command from the user to pause the video signal and a second command from the user to zoom in on a portion of the video signal displayed in the first area. It should be noted that the command from the user may instruct the interactive media guidance application to display a zoom window that is centered on a single frame or a plurality of frames.

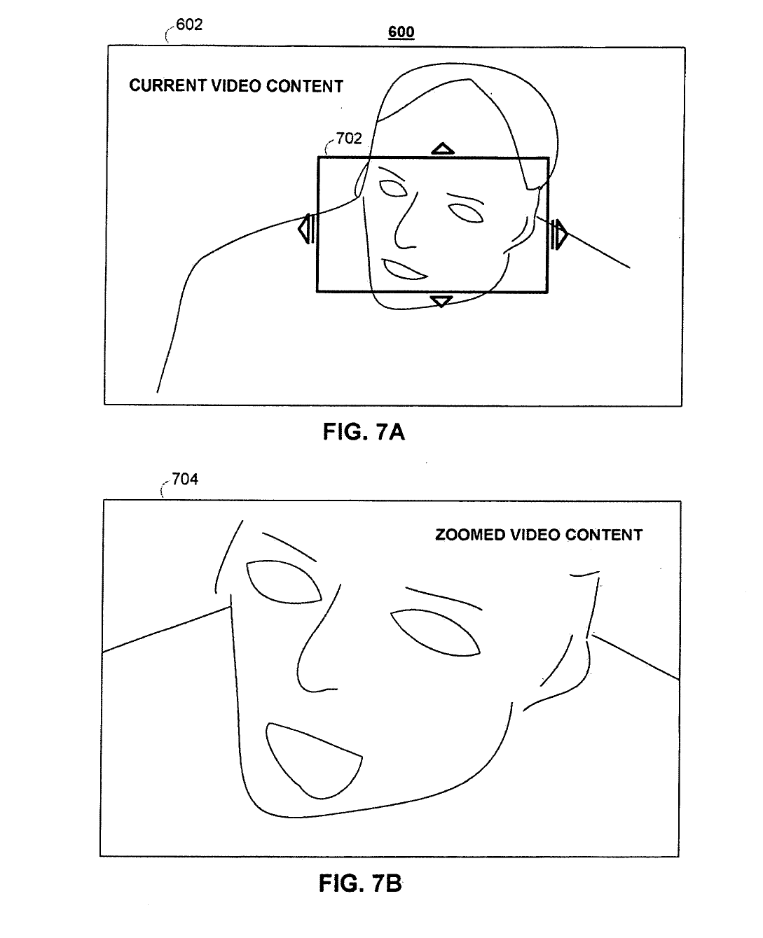

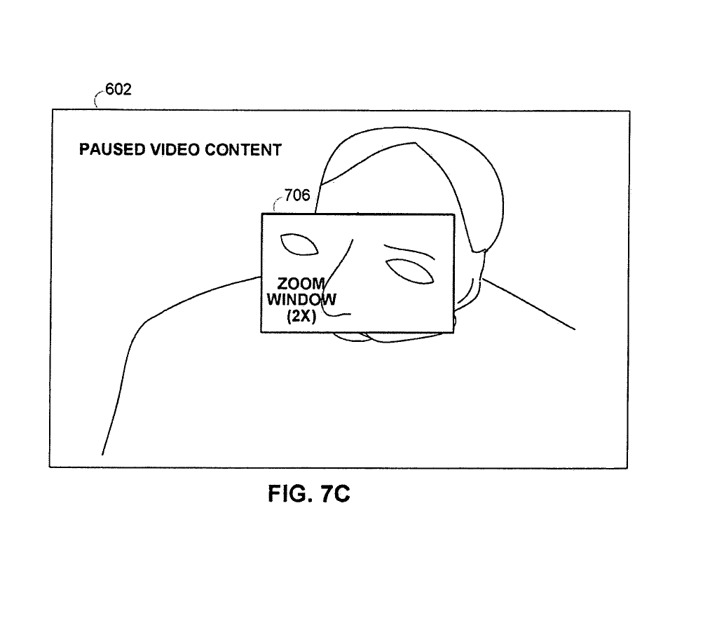

In response to receiving the one or more commands from the user to re-present or replay video content, the interactive media guidance application may select a second area of the video signal that is a portion of the first area (step 508) and causes the second area of the video signal to be presented on the display in a larger size than in the first area and first configuration (step 510). As shown, for example, in FIGS. 7A and 7B, the selected second area may be presented in a full screen display. As shown, for example, in FIG. 7C, the selected second area may be presented in a rectangular window that displays an enlarged portion of the video signal. The second area is enlarged such that it is larger than the second area of the video signal when displayed in the first configuration. It should be noted that, in some embodiments, the interactive media guidance application may enlarge the displayed zoomed video content without changing its resolution and clarity. Alternatively, the resolution and clarity of the zoomed video content may be comparable with respect to the resolution and clarity of the first area (e.g., by providing upconverted or up-scaled content). In some embodiments, the interactive media guidance application may smooth or soften the edges of the zoomed video content, minimize distortion artifacts on the zoomed video content, or apply any other suitable image correction or image processing feature.

Alternatively, in some embodiments, in response to receiving the commands from the user to re-present or replay video content, the interactive media guidance application may store the video signal on a digital storage device (e.g., a hard drive for a DVR (sometimes called a personal video recorder, or PVR) or any other suitable storage device).

It should be noted that, in some embodiments, the zoom window or the zoomed region may continually loop the enlarged video content until the interactive media guidance application receives a subsequent command from the user (e.g., the “play” button on the remote control). For example, upon displaying the zoomed video content, the interactive media guidance application may allow the user to rewind or advance through the video content using the remote control (e.g., using the arrow buttons on the remote control or using the “rewind” and “fast forward” buttons on the remote control). In response to receiving a command from the user, the interactive media guidance application may allow the user to replay the zoomed content at any suitable rate (e.g., slow motion, normal playback, frame by frame, etc.). When the end of the zoomed media content is reached (e.g., at the end of the particular play, when the zoomed media content has played to the point at which the content was paused, etc.), the interactive media guidance application may return back to the start of the zoomed video content. Alternatively, the zoom window or the zoomed region may present a single viewing of the enlarged frame or frames and continue to present the video signal from the point at which the content was paused.

In one example, the user (e.g., a sports fan) who would like to watch a replay of a close play or a questionable call that occurred while the user was watching a sporting event may select the “pause” button on the remote control. The questionable call or close play may be, for example, a penalty or a goaltending call in a basketball game, whether the basketball left the player's fingers before the buzzer sounded, who crossed the finish line of a race, whether a football player stepped out of bounds on a particular play, whether a football player crossed the goal line, whether a football player made a fair catch, whether a baseball player caught a ball, whether a baseball player should be called safe or out, whether a puck crossed the goal line, etc. In response to receiving one or more commands from the user, the interactive media guidance application may select a portion of the first area (the second area) that highlights the questionable call or the close play and enlarges the second area on the display. For example, the second area may include, a particular athlete or person, an animal, a foul line, an out-of-bounds line, a finish line, a ball, an object, etc.

It should be noted that the interactive media guidance application may be used in connection with any suitable content, where any suitable event may be enlarged with respect to the first area and the first configuration and replayed using the interactive media guidance application. For example, the interactive media application may be used in connection with science and nature shows, where the replayed event is an animal attacking its prey or the occurrence of a natural event (e.g., a volcanic eruption).

In some embodiments, the interactive media guidance application may automatically select the second area (or portion of the video signal) to be enlarged and replayed. For example, in response to receiving a command from the user (e.g., selecting the “pause” button on the remote control), the interactive media application may determine the time that the application received the command from the user and may determine the channel and/or content that the user is currently tuned to. In response, the interactive media application may provide a zoom window that enlarges a portion of the video signal at the time of the nearest event (e.g., the close play or the questionable call).

In some embodiments, the interactive media guidance application may receive metadata along with the video signal. The interactive media guidance application may use the metadata to automatically select the portion of the video signal to be enlarged and replayed. For example, the metadata may correspond to an object in the video signal, such as a baseball. The interactive media guidance application may use the metadata to automatically center on the baseball in the video signal. As another example, the metadata may correspond to a person in the video signal, such as the quarterback of a football team, an athlete, a celebrity, etc. In yet another example, the metadata may direct the interactive media application to automatically select an area centered on a body part (e.g., a hand, a foot, a head, etc.).

Alternatively, the interactive media guidance application may allow the user to select a portion of video signal using the remote control (or any other suitable user interface). For example, the interactive media guidance application may receive a command from the user to pause the video content provided in the display region and, in response, the interactive media guidance application may present a zoom window to the user. More particularly, in some embodiments, the interactive media application may allow the user to move the zoom window around the display region using the remote control or any other suitable interface.

In another example, if the interactive media application does not allow the user to zoom throughout the display region, the interactive media guidance application may automatically select an available zoom window that best fits the user-selected portion in response to the user selection. For example, in response to the user selecting a particular football player, the interactive media guidance application may automatically center the zoom window on the football player and the last play that the football player was involved. In another example, in response to the user highlighting a region where enhanced content for a zoom window is not available, the interactive media guidance application may provide an available zoom window with enhanced content nearest to the selected area.

Examples of displays and zoom windows are now illustrated in connection with FIGS. 6-11. Turning first to FIG. 6, the interactive media guidance application displays video content (e.g., a program) from the received video signal in video region 602. The content of video region 602 may correspond to, or be independent from, one of the listings displayed in grid 102 (FIG. 1).

In response to the user selecting, for example, a pause button on the remote control or providing any other suitable command, the interactive media guidance application presents a highlight window 702 as shown in FIG. 7A. Highlight window 702 is a rectangular window that the interactive media guidance application allows the user to select the portion of the currently displayed video content to be enlarged. Highlight window 702 may be resized and/or placed over any portion of the displayed video content using, for example, the arrow buttons on the remote control.

In response to selecting a portion of the displayed video content with highlight window 702, the interactive media guidance application may present an enlarged portion of the video signal in video region 704 as shown in FIG. 7B. Video region 704 is enlarged such that is it larger than the second area of the video signal when displayed in the first configuration illustrated in FIGS. 6 and 7A. For example, video region 704 may present an enlarged view of an athlete sliding into home plate or an enlarged view of two cars racing to a finish line. In another example, video region 704 may present an enlarged view of a celebrity walking down a runway with at least the same resolution and clarity as video region 602. In yet another example, video region 704 may present an enlarged view of a celebrity walking down a runway, where the interactive media guidance application has applied image processing features (e.g., anti-aliasing features) to the frames of the enlarged video content.

In some embodiments, in response to selecting a portion of the displayed video content with highlight window 702, the interactive media guidance application may present an enlarged portion of the video signal in a zoom window 706. The content displayed in zoom window 706 is enlarged such that it is larger than the second area of the video signal when displayed in the first configuration illustrated in FIGS. 6 and 7A.

The interactive media guidance application may allow the user viewing the zoomed content in FIGS. 7B and 7C to replay the zoomed content. For example, the interactive media guidance application may allow the user to rewind and playback the zoomed content from the time that the interactive media guidance application received the user command (e.g., the user pressing the pause button on the remote control). In another example, the interactive media guidance application may allow the user to step through the zoomed content or replay the zoomed content frame by frame or in slow motion. Using the remote control or any other suitable user interface, the interactive media application may allow the user to advance through the zoomed content at any suitable rate.

It should be noted that, in some embodiments, zoom window 702 may playback the enlarged portion of video content in a continuous loop. For example, zoom window 702 may continue to playback the content in a continuous loop until the interactive media guidance application receives a command from the user (e.g., pressing the “pause” button or the “play” button on the remote control). In some embodiments, zoom window 702 may present the enlarged frame or frames and continue to present the video signal from the point at which it was paused. The interactive media guidance application may provide the user with a playback option for selecting how content is replayed in zoom windows.

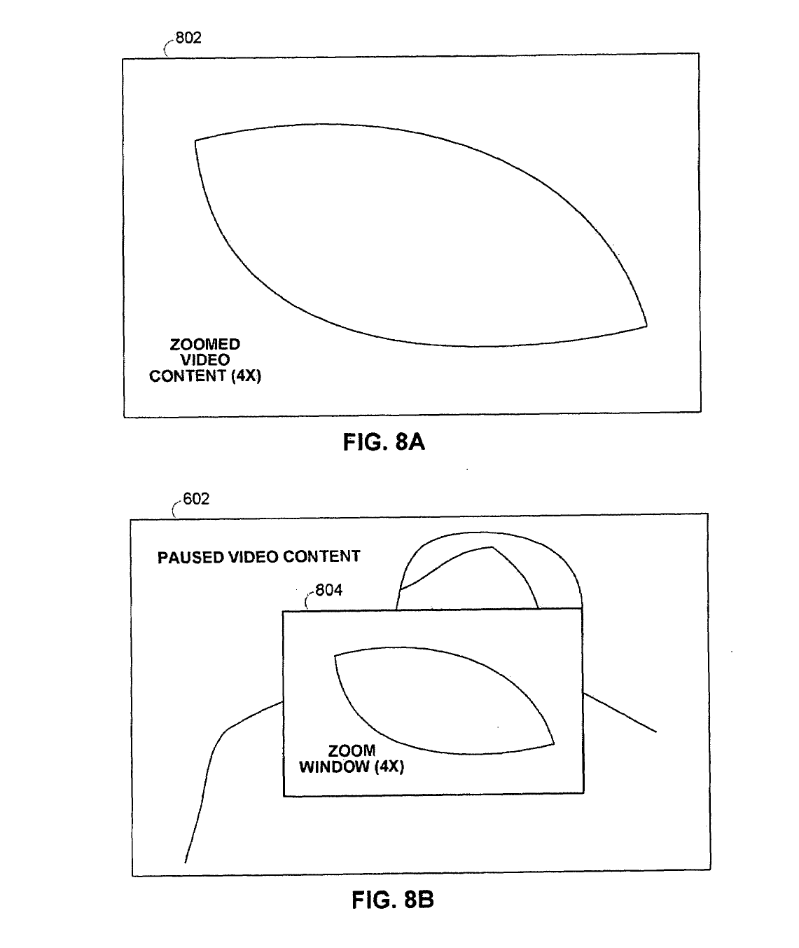

In some embodiments, the interactive media guidance application may allow the user to further zoom into the zoomed video content displayed in a display region (e.g., display region 704). In response to receiving a command from the user (e.g., pressing the “select” button on the remote control), the interactive media guidance application may enlarge the zoomed video content in display region 704 of FIG. 7B. As shown in display region 802 of FIG. 8A, in response to receiving a command from the user to enlarge the zoomed content, the interactive media guidance application has zoomed into the content to about two times the amount zoomed in display region 704. Similarly, the interactive media guidance application allows the user to continue to enlarge the zoomed video content (e.g., two times the originally zoomed video content, three times the originally zoomed video content, four times the originally zoomed video content, etc.). In response to receiving a command from the user (e.g., repeated depressions of the “select” button on the remote control), the interactive media guidance application transitions through the different magnifications available to the user.

Similarly, in some embodiments, the interactive media guidance application may allow the user to change the size of a zoom window and/or the content displayed in the zoom window (e.g., zoom window 706 of FIG. 7C). In response to receiving a command from the user (e.g., pressing the “select” button on the remote control), the interactive media guidance application may enlarge zoom window 706 of FIG. 7C. As shown in FIG. 8B, in response to receiving a command from the user to enlarge the zoom window, the interactive media guidance application has increased the size of zoom window 804 to about twice the size of zoom window 706. Similarly, the interactive media guidance application allows the user to continue to enlarge the size of the zoom window (e.g., two times the size of the original zoom window 706, three times the size of the original zoom window 706, four times the size of the original zoom window 706, etc.). In response to receiving a command from the user (e.g., repeated depressions of the “select” button on the remote control), the interactive media guidance application transitions through the different sizes of zoom windows available to the user. In some embodiments, the interactive media guidance application may present a zoom window that is the same size relative to the video region (e.g., region 602 of FIG. 6). In some embodiments, the interactive media guidance application may limit the size of the zoom window (e.g., zoom windows 706 of FIG. 7C and 804 of FIG. 8B) to the size of the video region 602.

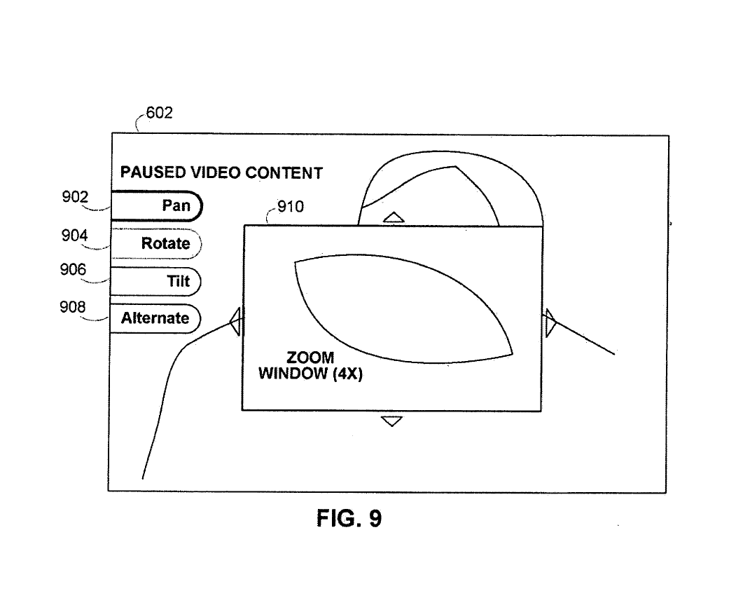

In some embodiments, the interactive media guidance application may present the user with a plurality of options corresponding to the zoom window. As shown in FIG. 9, pan option 902 allows the user to move the location of zoom window 910. For example, using the arrow buttons on the remote control, the interactive media guidance application may allow the user to select an alternate enlarged window. In another example, the interactive media guidance application may allow the user to pan the zoom window 804 with respect to the video region 602. Using pan option 902, when zoom window 910 is currently focused on a quarterback in a football game, the interactive media guidance application may allow the user to change the view to look over the right shoulder of the quarterback and, at a later time, over the left shoulder of the quarterback. In some embodiments, pan option 902 may be used to rotate a video camera (or its received signal) on its vertical or horizontal axis in order to keep a moving person or object in view.

In some embodiments, the interactive media guidance application may provide a user with enhanced content in response to receiving one or more commands from the user to re-present or reply video content. The enhanced content displayed in these zoom windows or video regions may be provided by media content sources, cameras controlled by a truck located outside of a sporting event, and/or any other suitable source.

For example, as also shown in FIG. 9, the interactive media guidance application provides the user with a rotate option 904 and a tilt option 906. Rotate option 904 allows the user to rotate the camera angle of the portion of the video signal. For example, when the zoom window is currently focused on a quarterback in a football game, the user may rotate the view around the quarterback using the arrow buttons on the remote control. Tilt option 906 allows the user to tilt the camera. For example, when the zoom window is currently focused on a quarterback in a football game, the user may tilt the camera to provide overhead views or ground views. In another example, when the zoom window is currently focused on a football player, the tilt option 906 allows the user to tilt the current view in zoom window 802 to determine whether the football player's knee touched the ground.

In some embodiments, the interactive media guidance application may provide the user with alternate camera views and/or alternate zoom windows. For example, the interactive media guidance application may present the user with zoom windows corresponding to different athletes on the field. In another example, the interactive media guidance application may present the user with zoom windows centered on different objects or body parts (e.g., a hand, a foot, etc.). In yet another example, the interactive media guidance application may present the user with zoom windows centered on different camera views (e.g., over the quarterback's left shoulder, over the quarterback's right shoulder, overhead view, etc.).

Any other suitable option may also be provided to the user by the interactive media guidance application, such as, for example, an additional zoom option that allows the user to enlarge an area within the already enlarged portion of the video signal.

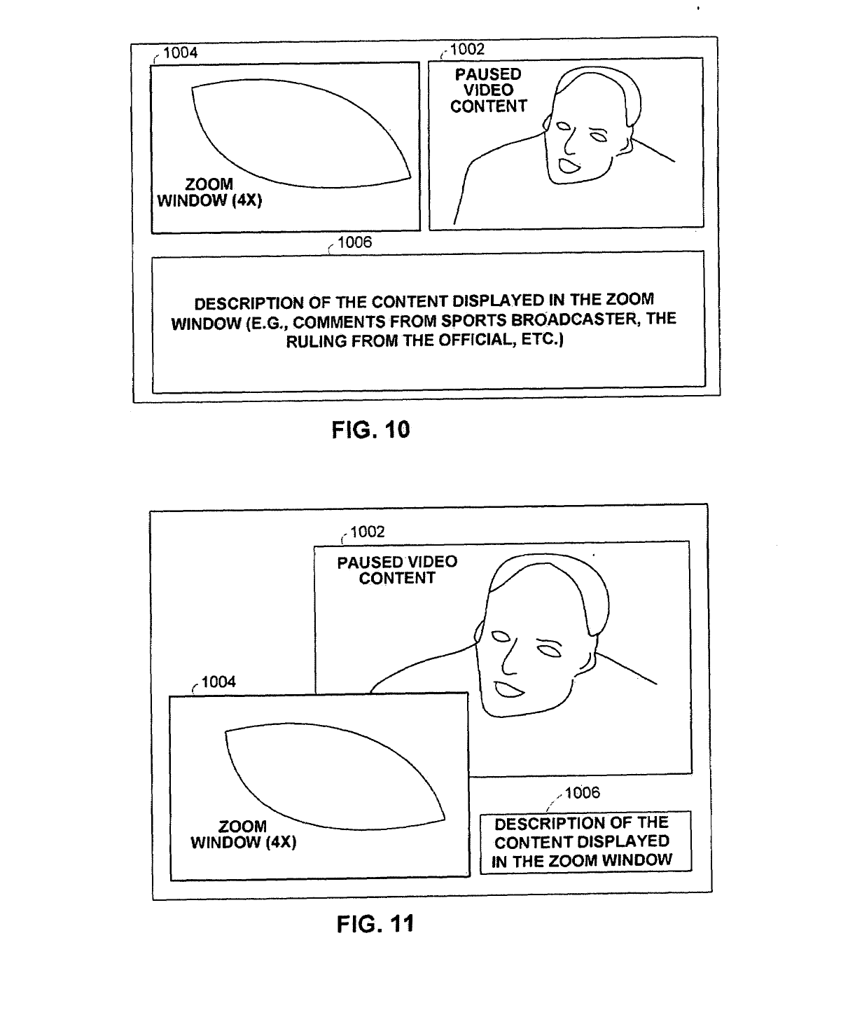

Alternate displays and zoom windows are illustrated in FIGS. 10 and 11. As shown, display 1000 of FIG. 10 includes video region 1002 and zoom window 1004 placed such that the size of video region 1002 is reduced from its size in the first configuration illustrated in FIGS. 6 and 7A. In addition, display 1000 includes description window 1006. Description window 1006 may include a description of the content displayed in zoom window 1004, such as, for example, comments from a sports broadcaster, a transcription of the audio portion of the broadcast, the ruling from the official, a description of the conditions, etc. Description window 1006, in some embodiments, may include comments from other users that are currently reviewing the same zoom window, comments from commentators or analysts on a channel that is different from the channel that the user is currently tuned to, or any other suitable information relating to the zoom window.

Alternatively, as shown in FIG. 11, zoom window 1004 may be overlaid over video region 1002 such that zoom window 1004 has a different center than video region 1002.

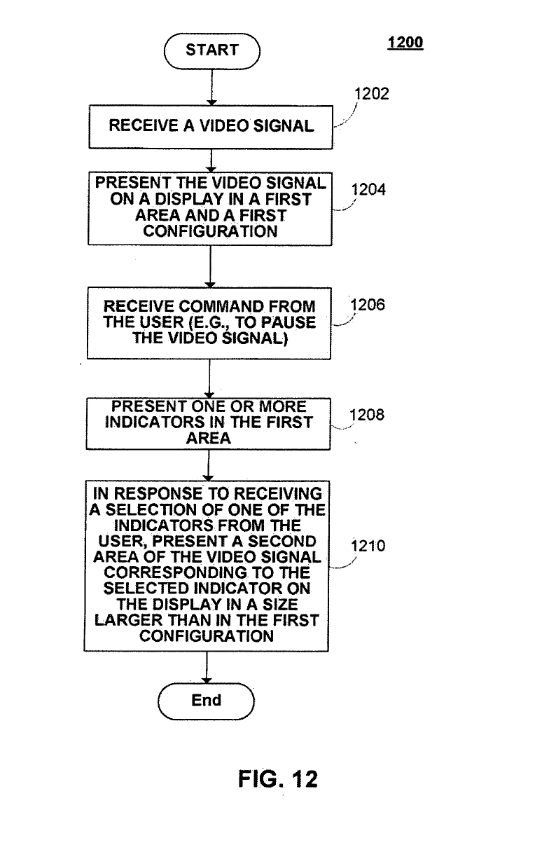

FIG. 12 illustrates a process 1200 for presenting indicators on the display that indicate what zoom windows are available for viewing in accordance with some embodiments. As shown, at step 1202, a video signal is received. Next, at step 1204, the video signal is presented on a display in a first area and a first configuration. In response to receiving one or more commands from the user (e.g., to pause the video signal) (step 1206), the interactive media guidance application may present one or more indicators that overlay the video content in the first area at step 1208. For example, the interactive media guidance application may display one or more numbers on the video region that correspond to the numbered buttons on the remote control or any other suitable interface. In another example, the interactive media guidance application may highlight different portions of the video content, where the user may scroll through the different available zoom windows using the arrow buttons on the remote control.

In some embodiments, the indicators that indicate what zoom windows are available may be ranked. For example, the indicators may be ranked based on the time at which the zoom window is available (e.g., the latest available time window is ranked with a “1”). In another suitable example, the indicators may be ranked based on user selection or based on popularity. The zoom windows that are most selected and viewed by users of the interactive media guidance application may be ranked higher than other zoom windows that are not selected as much by users (e.g., a close play at home play is ranked higher than a routine play made by an athlete). For live television events, these user statistics may build up and become more meaningful over time (e.g., one minute, ten minutes, one hours, etc.).

It should be noted that the interactive media guidance application may allow the indicators to be ranked using any suitable approach and/or by any suitable source. For example, in response to ESPN designating a particular play as a “Top Ten” nominee, the interactive media guidance application may rank the zoom window corresponding to the particular play higher than other zoom windows. ESPN is a trademark owned by ESPN, Inc. In another example, the zoom windows corresponding to events (e.g., close plays, questionable calls, etc.) that receive multiple replays by content providers may be ranked higher than other zoom windows.

It should also be noted that, although the indicators in FIGS. 12-14 are described as numbers corresponding to the numbers on the remote control, this is merely illustrative. The indicators may be colors, letters, shapes, symbols, and/or any other suitable indicators for allowing the user to select an available zoom window.

Referring back to FIG. 12, in response to receiving a selection of one of the indicators from the user, the interactive media guidance application may present a second area of the video signal that corresponds to the selected indicator (step 1210). The second area is displayed in a size larger than in the first area and in the first configuration.

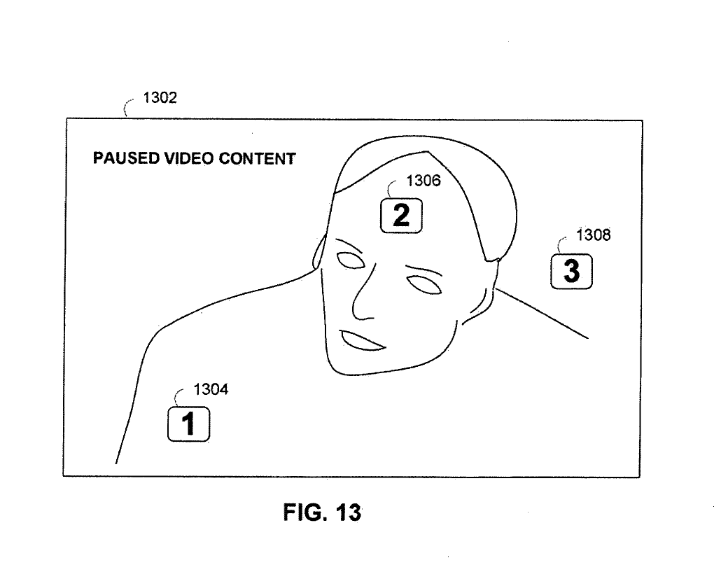

As shown in FIG. 13, in response to pausing the video content or receiving any other suitable command from the user to re-present or replay video content, the interactive media guidance application provides the user with available zoom windows indicated by indicators 1304, 1306, and 1308 in video region 1302.

Each indicator 1304, 1306, and 1308 may correspond to a person in the video signal, such as the quarterback of a football team, an athlete, a celebrity, an event, etc. In yet another example, the indicators 1304, 1306, and 1308 may direct the interactive media application to automatically select an area centered on a body part (e.g., a hand, a foot, a head, etc.). As shown in FIG. 13, while watching a football game, the user may be interested in three zoom windows for the quarterback—e.g., the quarterback's throwing arm (indicator 1304), the quarterback's head (indicator 1306), and over the quarterback's shoulder (indicator 1308).

In some embodiments, indicators 1304, 1306, and 1308 may be positioned at or near the same location in the video region 1302. For example, indicators 1304, 1306, and 1308 may correspond to different camera views of the same re-presentation of the video signal.

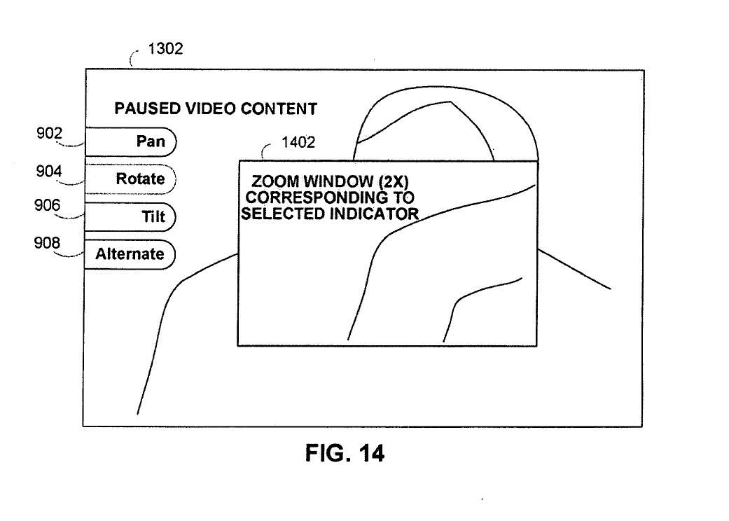

FIG. 14 shows an example of a display with a zoom window in accordance with some embodiments of the present invention. In response to the user selecting an indicator (e.g., one of indicators 1304, 1306, and 1308), the interactive media guidance application presents a zoom window 1402 that corresponds to selected indicator as shown in FIG. 14. Zoom window 1402 is a rectangular zoom window that presents an enlarged portion of the video signal. Zoom window 1402 may be enlarged such that it is larger than the second area of the video signal when it was displayed in the first configuration. For example, zoom window 1402 may present an enlarged view of the quarterback diving over the goal line.

In some embodiments, the interactive media guidance application may allow the user to select multiple indicators (e.g., at least two of indicators 1304, 1306, and 1308). In response to the user selecting multiple indicators, the interactive media guidance application may present the user with corresponding zoom windows with enhanced content for each of the selected indicators.

In some embodiments, the interactive media guidance application may allow the user to provide feedback to the interactive media guidance application, such as indicating the user's opinion on a particular event. For example, while watching an instant replay of a football play in a zoom window, the interactive media guidance application may allow the user to indicate whether the user believes that the football player stepped out of bounds (e.g., “Press 1 on your remote control to indicate that the player was out of bounds and press 2 on your remote control to indicate that the player was in-bounds.”). In response to receiving the feedback from the user, the interactive media guidance application may provide statistics and/or other suitable information to the user. For example, the interactive media guidance application may overlay statistics on the zoom window that indicate the combined feedback from users of the interactive media guidance application (e.g., “80% of users thought the player was out of bounds”).

Thus, it is seen that methods and systems for presenting a guidance application are provided. One skilled in the art will appreciate that the invention can be practiced by other than the described embodiments, which are presented for purposes of illustration and not of limitation, that various features of the described embodiments can be interchanged and used in any suitable combination, and that the present invention is limited only by the claims which follow.

What is claimed is:

1. A method for presenting an interactive media guidance application in a user equipment device, comprising:
receiving a video signal;
presenting the video signal on a display in a first area and in a first configuration;
receiving one or more commands from a user; and
in response to receiving the one or more commands:
selecting a second area of the video signal that is less than the first area of the video signal; and
causing the second area of the video signal to be presented on the display in a larger size than the second area of the video signal when displayed in the first configuration.

2. The method of claim 1, further comprising storing the video signal on a digital storage device and pausing the presentation of the video signal.

3. The method of claim 1, wherein the video signal has a single frame.

4. The method of claim 1, wherein the video signal includes a plurality of frames.

5. The method of claim 4, further comprising re-presenting the second area of the video signal corresponding to the plurality of frames.

6. The method of claim 4, further comprising re-presenting the second area of the video signal corresponding to the plurality of frames in a loop.

7. The method of claim 1, wherein the one or more commands includes a command that selects which portion of the first area is selected as the second area.

8. The method of claim 7, wherein the command pans the second area with respect to the first area.

9. The method of claim 1, wherein the one or more commands changes the relative size of the second area to the first area.

10. The method of claim 1, wherein the one or more commands zooms into a portion of the first area and presents the zoomed in portion of the first area on the display.

11. The method of claim 1, wherein the one or more commands zooms into a portion of the first area and presents the zoomed in portion of the first area in the second area.

12. The method of claim 1, further comprising graphically indicating the second area on the display.

13. The method of claim 1, wherein the second area is automatically selected based on a characteristic of the video signal.

14. The method of claim 1, wherein the interactive media guidance application is an interactive program guide.

15. A device for presenting an interactive media guidance application, comprising:
processing circuitry that:
receives a video signal;
causes the video signal to be presented in a first area and in a first configuration;
receives one or more commands from a user; and
in response to receiving the one or more commands:
selects a second area of the video signal that is less than the first area of the video signal; and
causes the second area of the video signal to be presented in a larger size than the second area of the video signal when displayed in the first configuration.

16. The device of claim 15, further comprising a digital storage device, wherein the processing circuitry is further configured to store the video signal on the digital storage device and pause the presentation of the video signal.

17. The device of claim 15, wherein the video signal has a single frame.

18. The device of claim 15, wherein the video signal includes a plurality of frames.

19. The device of claim 18, wherein the processing circuitry is further configured to re-present the second area of the video signal corresponding to the plurality of frames.

20. The device of claim 18, wherein the processing circuitry is further configured to re-present the second area of the video signal corresponding to the plurality of frames in a loop.

21. The device of claim 15, wherein the one or more commands includes a command that selects which portion of the first area is selected as the second area.

22. The device of claim 21, wherein the command pans the second area with respect to the first area.

23. The device of claim 15, wherein the one or more commands changes the relative size of the second area to the first area.

24. The device of claim 15, wherein the one or more commands zooms into a portion of the first area, and wherein the processing circuitry is further configured to cause the zoomed in portion of the first area to be presented on the display.

25. The device of claim 15, wherein the one or more commands zooms into a portion of the first area, and wherein the processing circuitry is further configured to cause the zoomed in portion of the first area to be presented in the second area.

26. The device of claim 15, wherein the processing circuitry is further configured to graphically indicate the second area on the display.

27. The device of claim 15, wherein the processing circuitry is further configured to automatically select the second area based on a characteristic of the video signal.

28. The device of claim 15, wherein the interactive media guidance application is an interactive program guide.

29. A device for presenting an interactive media guidance application in a user equipment device, comprising:
means for receiving a video signal;
means for presenting the video signal on a display in a first area and in a first configuration;
means for receiving one or more commands from a user; and
in response to receiving the one or more commands:
means for selecting a second area of the video signal that is less than the first area of the video signal; and
means for presenting the second area of the video signal on the display in a larger size than the second area of the video signal when displayed in the first configuration.

30. The device of claim 29, further comprising means for storing the video signal on a digital storage device and means for pausing the presentation of the video signal.

31. The device of claim 29, wherein the video signal has a single frame.

32. The device of claim 29, wherein the video signal includes a plurality of frames.

33. The device of claim 32, further comprising means for re-presenting the second area of the video signal corresponding to the plurality of frames.

34. The device of claim 32, further comprising means for re-presenting the second area of the video signal corresponding to the plurality of frames in a loop.

35. The device of claim 29, wherein the one or more commands includes a command that selects which portion of the first area is selected as the second area.

36. The device of claim 35, wherein the command pans the second area with respect to the first area.

37. The device of claim 29, wherein the one or more commands changes the relative size of the second area to the first area.

38. The device of claim 29, wherein the one or more commands zooms into a portion of the first area, and further comprises means to present the zoomed in portion of the first area on the display.

39. The device of claim 29, wherein the one or more commands zooms into a portion of the first area, and further comprises means to present the zoomed in portion of the first area in the second area.

40. The device of claim 29, further comprising means for graphically indicating the second area on the display.

41. The device of claim 29, further comprising means for automatically selecting the second area based on a characteristic of the video signal.

42. The device of claim 29, wherein the interactive media guidance application is an interactive program guide.
